(19) United States
(12) Patent Application Publication
(10) Pub. No.: US 2016/0016235 A1
(43) Pub. Date: Jan. 21, 2016

(54) MODULAR TOOL HOLDER WITH DIVERSE CUTTING TOOLS ASSEMBLY

(71) Applicant: CHING-TING CHEN, TAICHUNG CITY (TW)

(72) Inventor: CHING-TING CHEN, TAICHUNG CITY (TW)

(21) Appl. No.: 14/334,691

(22) Filed: Jul. 18, 2014

(51) Int. Cl. B23B 31/11

(52) U.S. Cl. CPC B23B 31/11; B23B 2231/0296; B23B 2231/24

(57) ABSTRACT

A modular tool holder with diverse cutting tools assembly includes a holder body, an adjusting screw and a blind bolt and a cutting tool. The holder body has a clamping section defined at a front side and a mounting hole formed through along an axis of the holder body. The adjusting screw is mounted in the middle of the mounting hole and has a first tool recess and a second tool recess formed on a head portion. The blind bolt is mounted in a rear side of the mounting hole. The cutting tool is mounted in a front side of the mounting hole and abuts to the clamping section. The cutting tool and the holder body are firmly connected and are double-restricted status. A user can use any one of different types of hand tools to rotate the adjusting screw to remove the cutting tool easily.

### BACKGROUND OF THE INVENTION

1. Field of the Invention

The present invention relates to a tool holder assembly, and more particularly to a modular tool holder with diverse cutting tools assembly.

2. Description of Related Art

The conventional tool holder has an outer periphery and a mounting hole. Because the outer periphery of the tool holder and the mounting hole are tapped in shaped, the thickness of a front side of the tool holder is thicker and causes the structure of the tool holder lack of strength. Therefore, the cutting tool easily generates vibration when working in a heavy or high-speed cutting environment, and further affects the precision of manufacturing.

Additionally, the conventional tool holder uses an adjusting screw to connect the cutting tool, but the adjusting screw only can be rotated by one kind of a particular tool and is inconvenient in use.

To overcome the shortcomings of the conventional tool holder, the present invention provides a modular tool holder with a diverse cutting tools assembly to mitigate or obviate the aforementioned problems.

### SUMMARY OF THE INVENTION

A modular tool holder with diverse cutting tools assembly includes a holder body, an adjusting screw and a blind bolt and a cutting tool. The holder body has a clamping section defined at a front side and a mounting hole formed through along an axis of the holder body. The adjusting screw is mounted in the middle of the mounting hole and has a first tool recess and a second tool recess formed on a head portion. The blind bolt is mounted in a rear side of the mounting hole. The cutting tool is mounted in a front side of the mounting bole and abuts to the clamping section. The cutting tool and the holder body are firmly connected and are double-restricted status. User can use any one of different types of hand tools to rotate the adjusting screw to remove the cutting tool easily.

Other objects, advantages, and novel features of the invention will become more apparent from the following detailed description when taken in conjunction with the accompanying drawing.

### BRIEF DESCRIPTION OF THE DRAWINGS

FIG. 1 is a perspective view of a modular tool holder with diverse cutting tools assembly in accordance with the present invention;

FIG. 2 is an exploded cross-sectional perspective view of the modular tool holder with diverse cutting tools assembly in FIG. 1;

FIG. 3 is a cross-section front view of the modular tool holder with diverse cutting tools assembly in FIG. 1;

FIG. 3A is an enlarged cross-section front view of the modular tool holder with diverse cutting tools assembly in FIG. 3;

FIG. 4 is an operational cross-section front view of the modular tool holder with diverse cutting tools assembly in FIG. 3;

FIG. 5 is an operational perspective view of the modular tool holder with diverse cutting tools assembly in FIG. 1;

FIG. 6 is a cross-sectional perspective view of a second embodiment of the modular tool holder with diverse cutting tools assembly in accordance with the present invention;

FIG. 7A shows an operational cross-section front view of the modular tool holder with diverse cutting tools assembly in FIG. 6, showing a blind bolt remove from a holder body;

FIG. 7B shows an operational cross-section front view of the modular toot holder with diverse cutting tools assembly in FIG. 6, showing a star screwdriver driving an adjusting screw to remove a cutting tool;

FIG. 8 is a cross-section left view of a the modular tool holder with diverse cutting tools assembly in FIG. 7B;

FIG. 9A shows another operational cross-section front view of the modular tool holder with diverse cutting tools assembly in FIG. 6, showing the blind bolt remove from the holder body;

FIG. 9B shows another operational cross-section front view of the modular tool holder with diverse cutting tools assembly in FIG. 6, showing a hex wrench driving the adjusting screw to remove the cutting tool;

FIG. 10 is another cross-section left view of a the modular tool holder with diverse cutting tools assembly in FIG. 9B;

### DETAILED DESCRIPTION OF PREFERRED EMBODIMENT

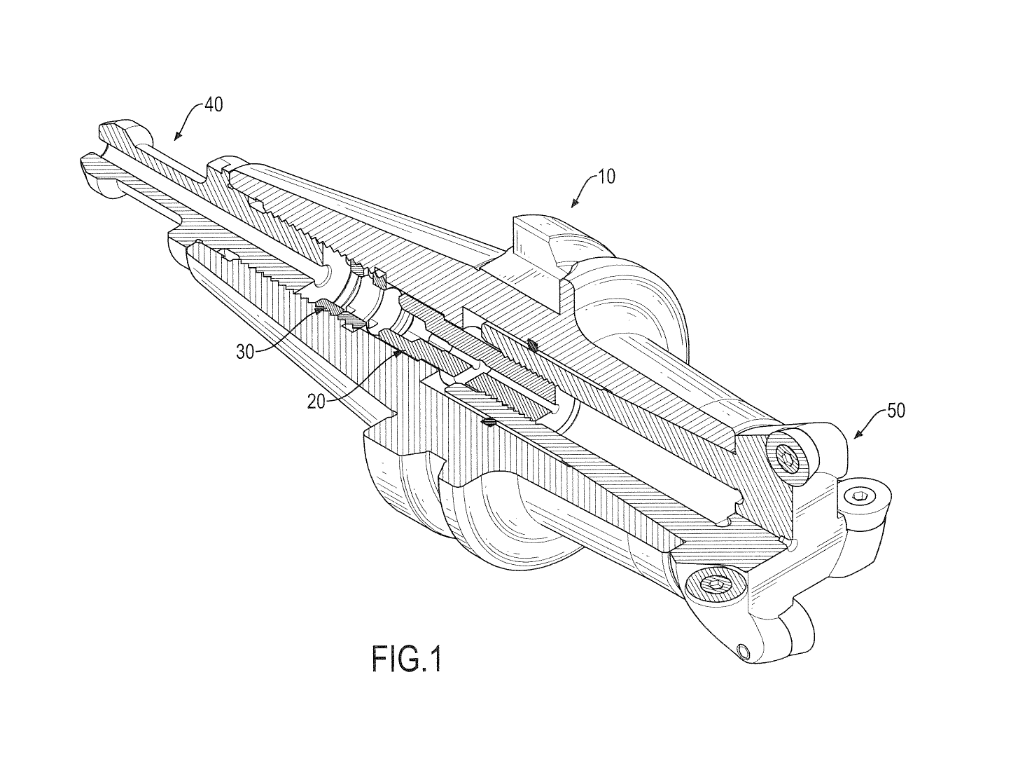

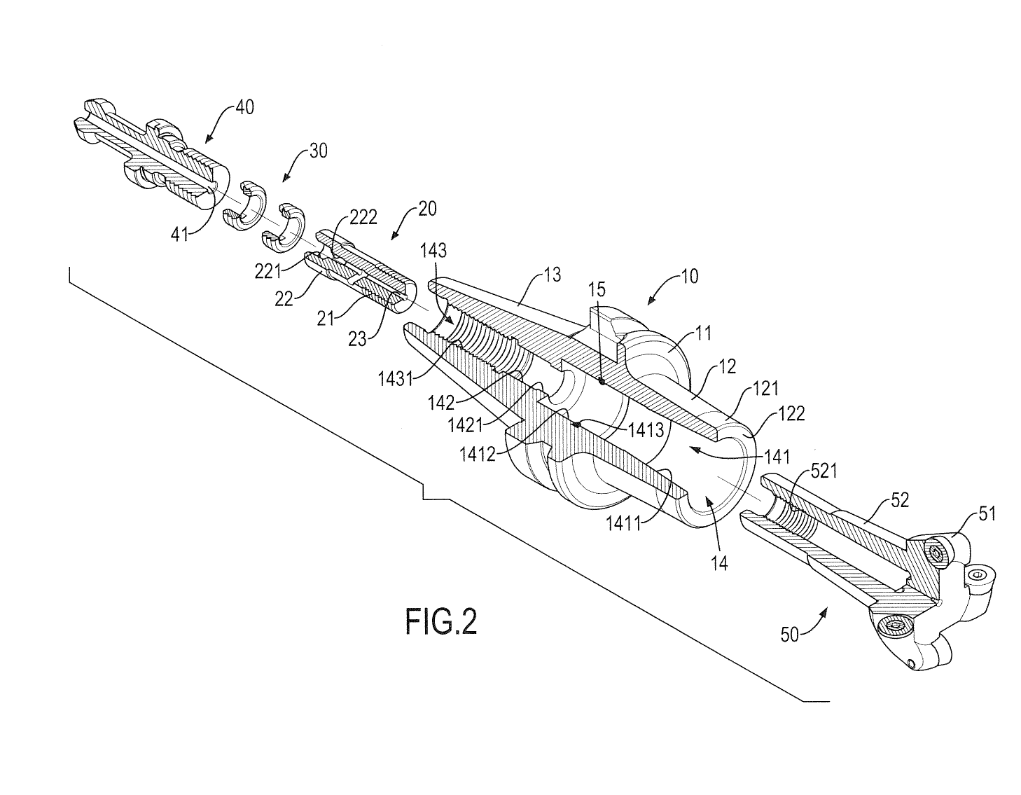

With reference to FIGS. 1 and 2, a first embodiment of a modular tool holder with diverse cutting tools assembly includes a holder body 10, an adjusting screw 20, two set screws 30, a blind bolt 40 and a cutting tool 50.

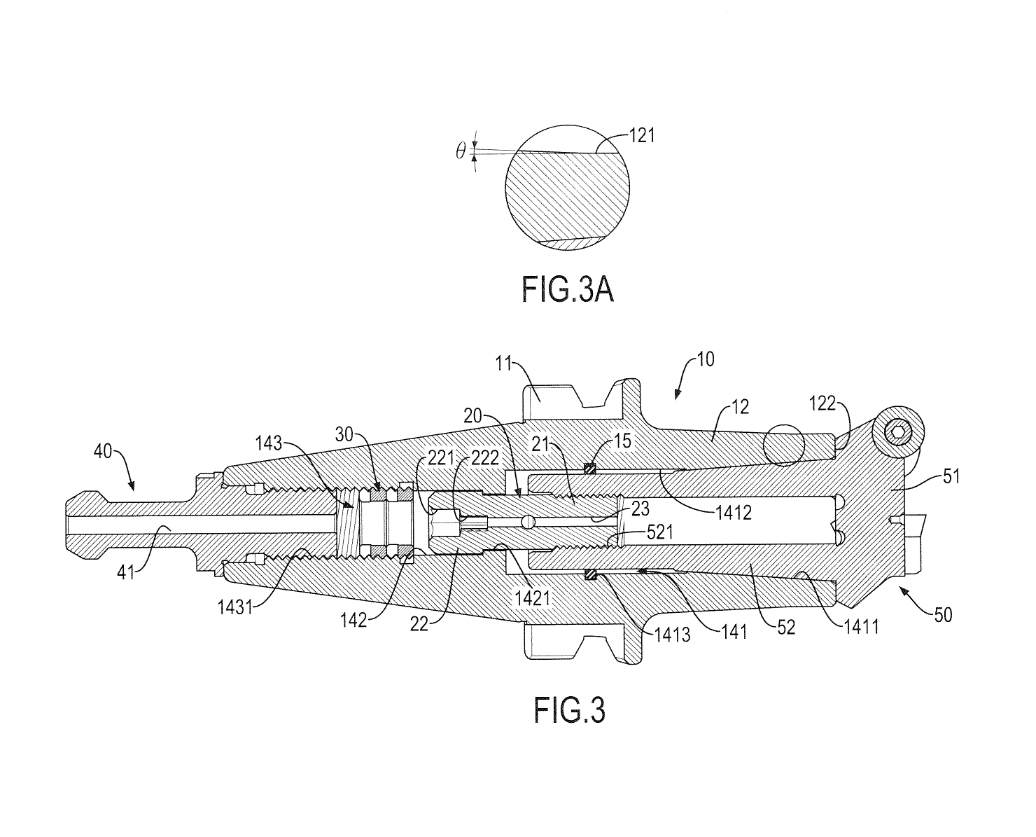

With reference FIGS. 1 and 2 right side of FIG. 1 corresponds to a front side of the holder body 10 and a left side of FIG. 1 corresponds to a rear side of the holder body 10. The holder body 10 has an outer periphery, a flange 11, a clamping section 12, an installing section 13, a mounting hole 14 and a seal ring 15. The flange 12 is formed around the outer periphery of the holder body 10 and is divided into the holder body 10 as the clamping section 12 and the installing section 13 located at the opposite side of the clamping section 12. With reference to FIGS. 3 and 3A, the clamping section 12 is located in front of the flange 11 and has a flat section 121 and an abutment face 121. The clamping section 12 is conical in shaped except the flat section 121. The flat section 121 is defined around a front segment of the clamping section 12 and has an identical outer diameter small than the diameter of the clamping section 12, which formed a angle θ between a periphery of the flat section 121 and the boundary of clamping section 12. The abutment face 122 is defined on a front end of the clamping section 12.

The mounting hole 14 formed through along an axis of the holder body 10 and is a multiple steps hole. The mounting hole 14 is sequentially divided into a tool assembling section 141, a screw mounting section 142 and a blind bolt mounting section 143 from the front side to the rear side. The tool assembling section 141 is adjacent to the abutment face 122. The tool assembling section 141 has a front segment 1411 and a rear segment 1412. An inner diameter of the front segment is tapped and gradually decreases from the front side to the rear side. An inner diameter of the rear segment 1412 of the tool assembling section 141 is identical. Preferably, a ring groove 1413 is formed around an inner periphery of the rear segment 1412 of the tool assembling section 141.

The screw mounting section 142 communicates with the tool assembling section 141 and has a neck portion form at the common boundary of the screw mounting section 142 and the tool assembling section 141. A diameter of the neck portion 1421 is small than the diameter of the tool assembling section 141 and the diameter of the screw mounting section 142. The bolt mounting section 143 communicates with the screw mounting section 142 and has a screw thread surface 1431 formed around the bolt mounting section 143. The seal ring 15 is mounted in the ring groove 1413.

With reference to FIGS. 1 and 2, the adjusting screw 20 is mounted in the screw mounting section 142 and has a connecting end 21, a head portion 22 and a water outlet 23. The connecting end 21 of the adjusting screw 20 protrudes in the tool assembling section 141 and has screw threads. The head portion 22 is located opposite to the connecting end 21 and has a first tool recess 221 and a second tool recess 222 formed on a bottom of the first tool recess 221. The diameter of the first tool recess 221 is larger than the diameter of the second tool recess 222. Preferably, the first tool recess 221 is hexagonal in shape and the second tool recess 222 is star in shaped. The water outlet 23 is formed through the connecting end 21 to the head portion 22.

With reference to FIGS. 2 and 3, the set screws 30 are mounted in a front segment of the blind bolt mounting section 143 in from and back order. The blind bolt 40 is mounted in a rear segment of the blind bolt mounting section 143, has a water inlet 41 formed through the blind bolt 40 and communicating with the screw mounting section 142.

With reference to FIGS. 2 and 3, the cutting tool 50 is mounted in the front side of the holder body 10 and including a cutting portion 51 and a tool shank 52. A back surface of the cutting portion 51 abuts the abutment face 122 of the clamping section 12 to make the cutting tool 50 and the holder body 10 become double-restricted status which has high stabilities and sealed connections between the cutting tool 50 and the holder body 10.

The shank 52 protrudes from the back surface of the cutting portion and is mounted in the tool assembling section 141 of the mounting hole 14 and abuts an inner periphery of the seal ring 15 to increase the stabilize of the connection between the shank 52 and the mounting hole 14. A fixing hole 521 is formed in the shank 52, communicates with the water outlet 23 and has screw threads formed around an inner periphery of the fixing hole 521. The connecting end 21 of the adjusting screw 20 is screwed in the fixing hole 521.

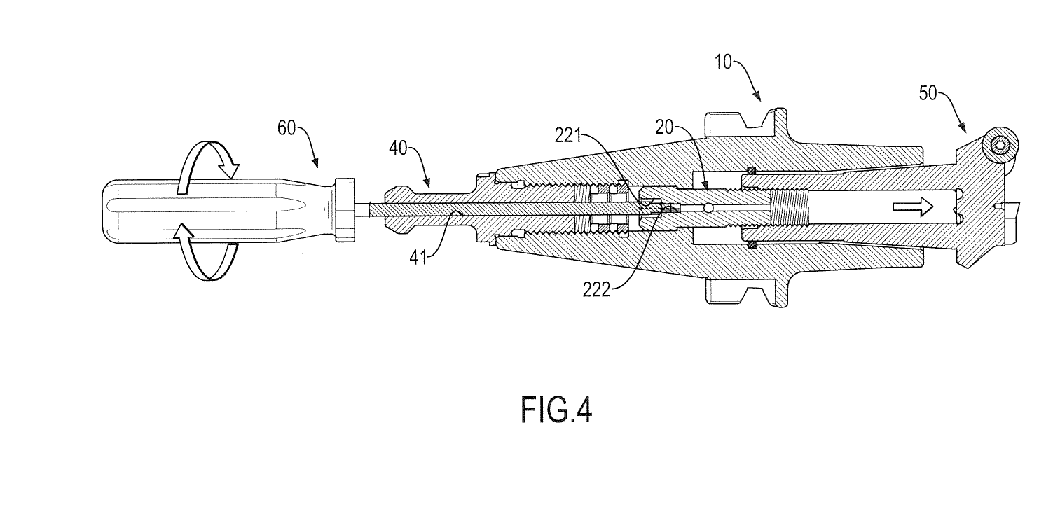

With reference to FIG. 4, to remove the cutting tool 50 from the holder body 10, a user can use a hand tool 60 inserting into one of the tool recess 221,222 via the water inlet 41 and the set screws 30 and rotating the hand tool 60 to rotate the adjusting screw 20. Thus, the cutting tool 50 can be able to remove by rotating the adjusting screw 20 while the adjusting screw 20 moving back until abutting to the front set screws 30. The user can freely choose the hand tool 60 and rotates the adjusting screw 20 without removing the blind bolt 40. The hand tool 60 may be a star screwdriver or a hex wrench.

Furthermore, the flat section 121 of the clamping section 12 has a thinner thickness and an identical diameter, and is different to the conventional conical tool holder having a tapered diameter and multiple different thicknesses. Therefore, the flat section 121 can firmly clamp the cutting tool 50 and makes the cutting portion 51 of the cutting tool 50 abut to the abutment face 122 closely.

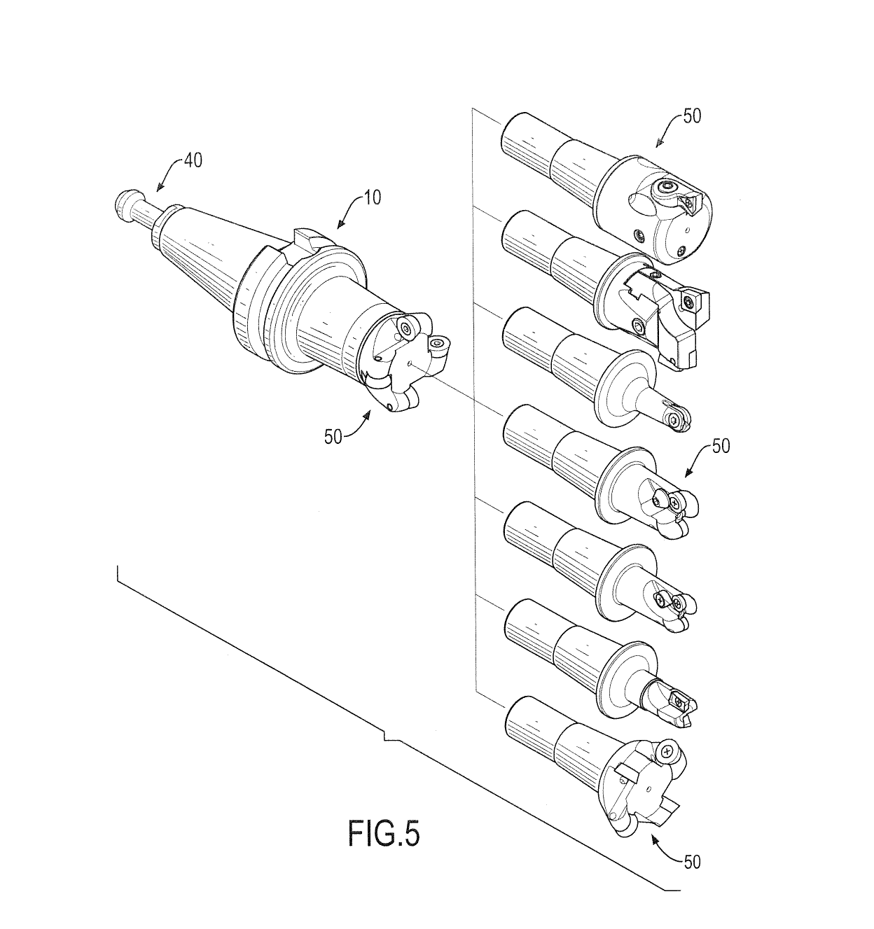

With reference to FIG. 5 the present invention is able to assemble any kinds of the cutting tools 50 with diverse cutting portions 51 to use in different environments.

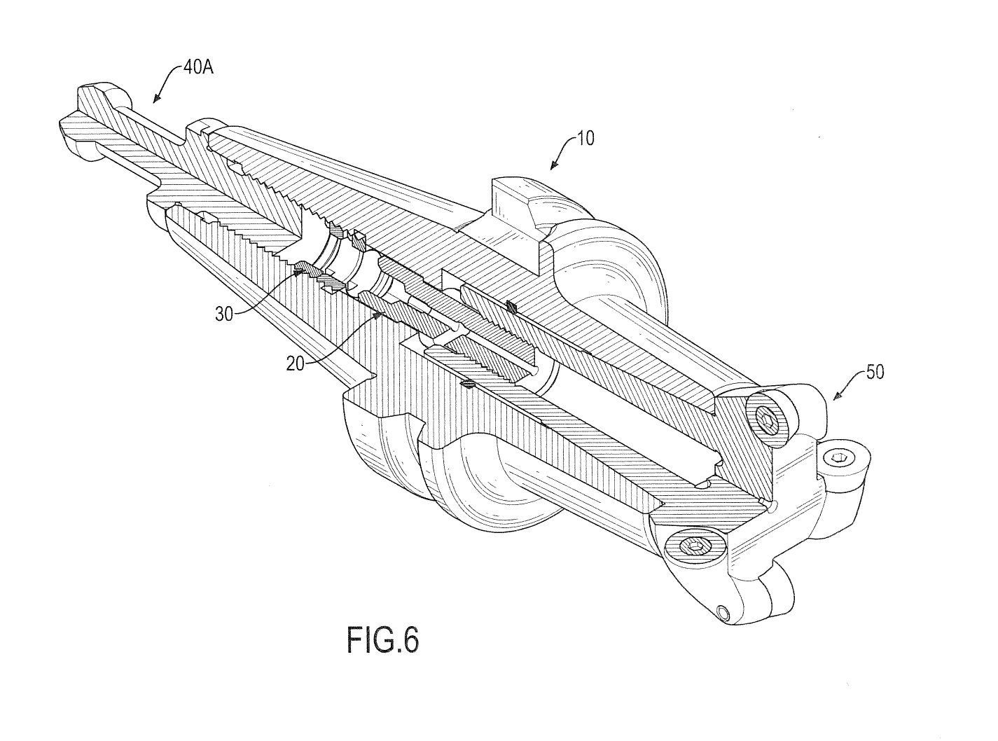

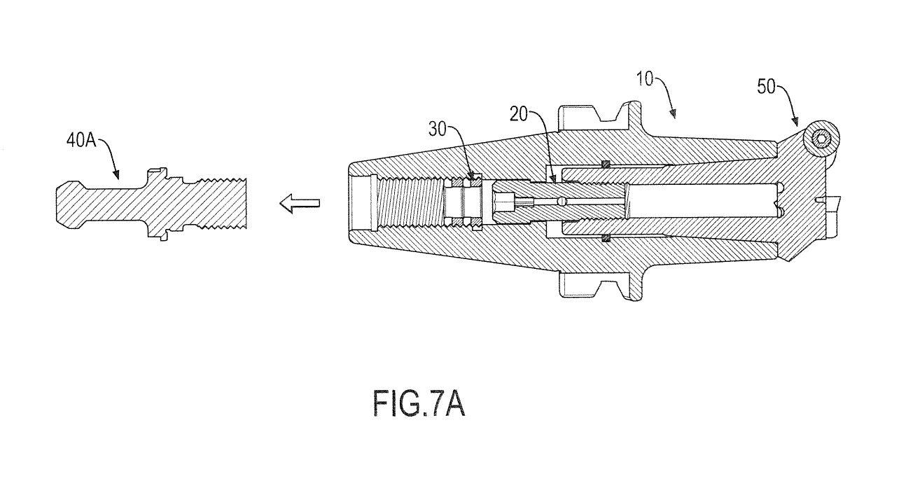

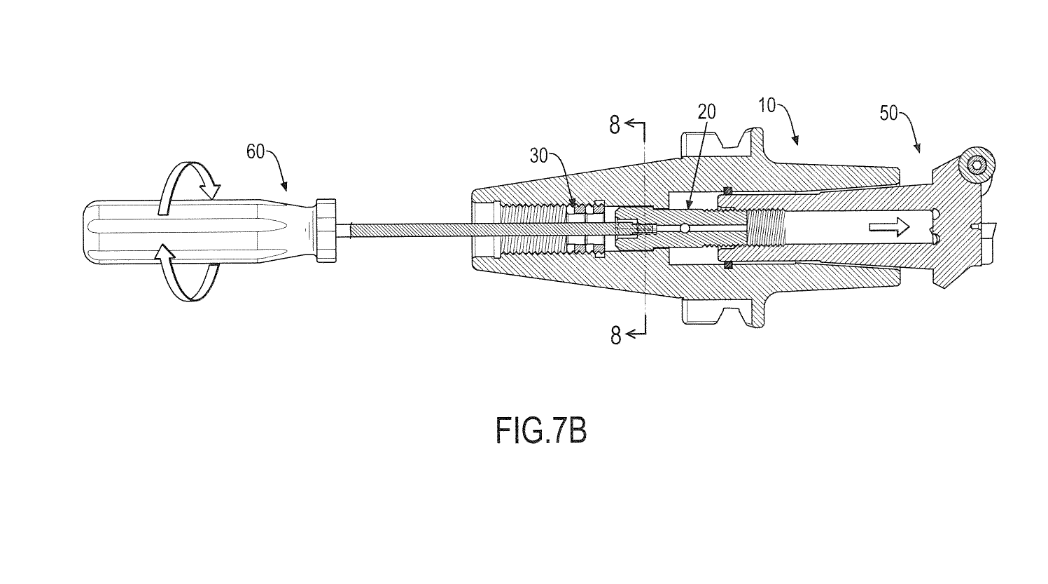

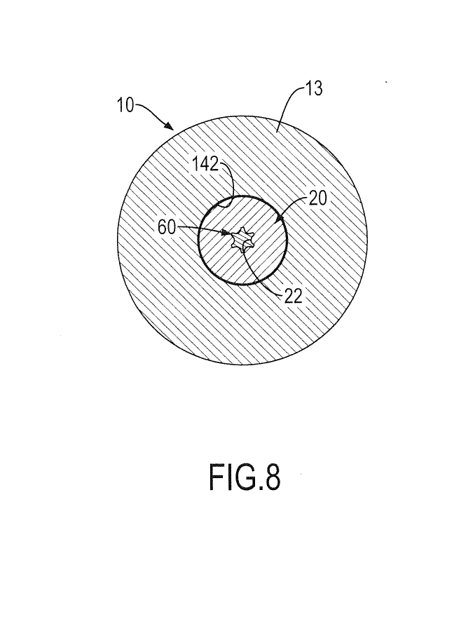

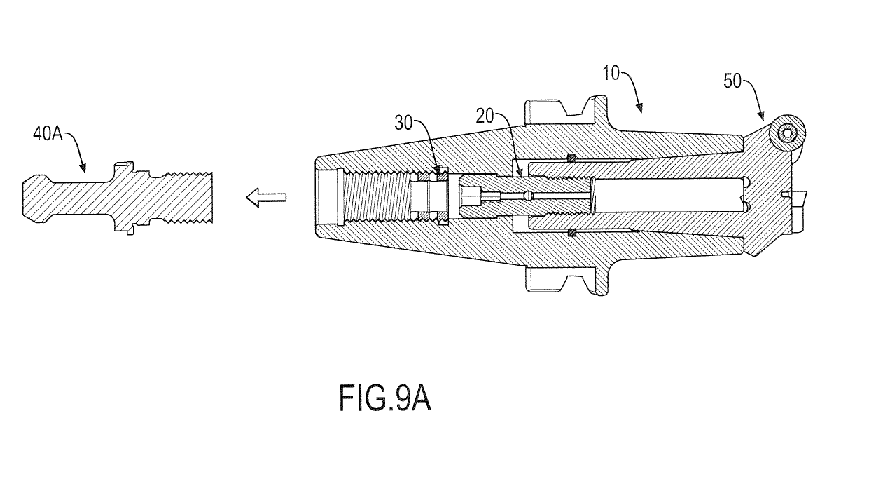

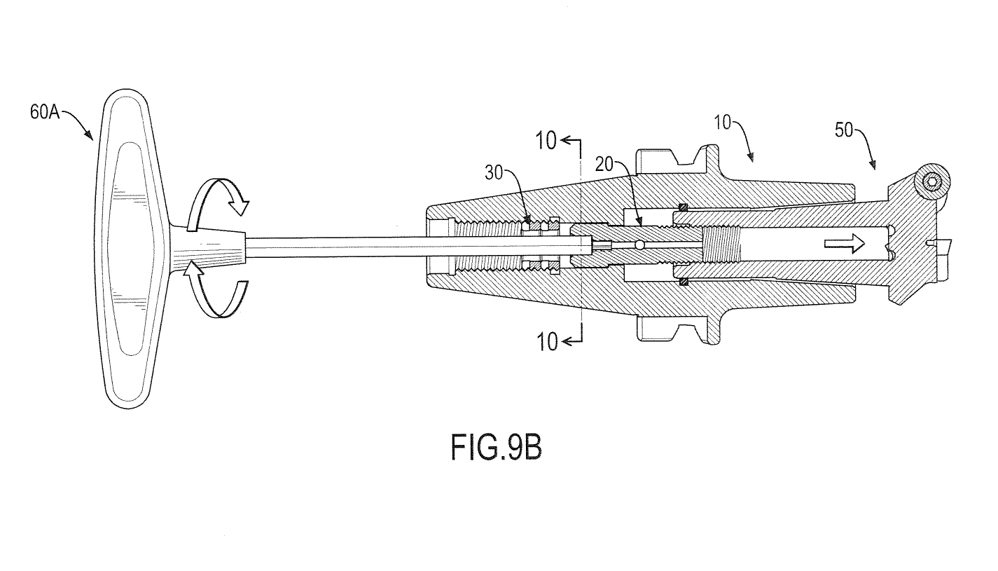

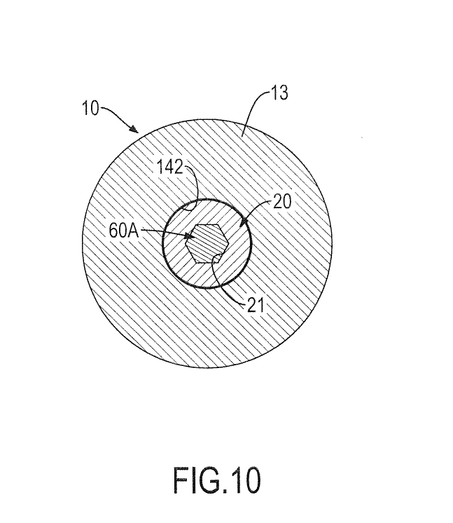

With reference to FIGS. 6 to 10, in a second embodiment of a modular tool holder with diverse cutting tools assembly in accordance with the present invention, the elements and effects of the second embodiment are same with those of the first embodiment except the blind bolt 40A is a traditional blind bolt. With reference to FIGS. 7A, 7B, 9A and 9B show the present invention in use, the blind bolt 40A has to remove from the holder body 10, and then the user can use a hand tool 60,60A to rotate the adjusting screw and removes the cutting tool 50 from the holder body 10. Preferably, the hand tool 60 is a star screwdriver corresponding to the second tool recess 222; the hand tool 60A is a hex wrench corresponding to the first tool recess 221.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A modular tool holder with diverse cutting tools assembly comprising:
a holder body having
a clamping section defined at a front side of the holder body and having
a flat section defined around a front segment of the clamping section and has an identical outer diameter;
an abutment face defined on a front end of the clamping section;
a mounting hole formed through along an axis of the holder body, being a multiple steps hole and sequentially divided into a tool assembling section, a screw mounting section and a blind bolt mounting section from the front side to the rear side, wherein
the tool assembling section has a front segment and a rear segment, the front of the tool assembling section is tapped and an inner diameter gradually decreases from the front side to the rear side, the rear segment has an inner diameter being identical and a ring groove formed around an inner periphery of rear segment;
a seal ring mounted in the ring groove of the tool assembling section;
an adjusting screw mounted in the screw mounting section and having
a connecting end protruding in the tool assembling section and having screw threads;
a head portion located being opposite to the connecting end and having a first tool recess and a second tool recess formed on a bottom of the first tool recess;
a water outlet formed through the connecting end to the head portion;
a blind bolt mounted in a rear segment of the blind bolt mounting section
at least one set screw mounted in a front segment of the blind bolt mounting section and located between the blind bolt and the adjusting screw; and
a cutting tool mounted in the front side of the holder body and including
a cutting portion having a back surface abutting the abutment face of the clamping section; and
a tool shank protruding from the back surface of the cutting portion and mounted in the tool assembling section of the mounting hole and abutting the seal ring.

2. The modular tool holder with diverse cutting tools assembly as claimed in claim 1, wherein the first tool recess of the adjusting screw is hexagonal in shape and the second tool recess of the adjusting screw is star in shaped.

3. The modular tool holder with diverse cutting tools assembly as claimed in claim 2, wherein the blind bolt has a water inlet formed through the blind bolt and communicating with the screw mounting section.
